(19) United States
(12) Patent Application Publication
(10) Pub. No.: US 2026/0180477 A1
(43) Pub. Date: Jun. 25, 2026

(54) Method for Starting an EC Motor, Assembly, Tool, and Devices

(71) Applicant: Andreas Stihl AG & Co. KG, Waiblingen (DE)

(72) Inventors: Tim Däweritz, Waiblingen (DE); Simon Dietrich, Waiblingen (DE); Patrick Wiesa, Besigheim (DE); Jan Lukas Jackenkroll, Remseck (DE)

(73) Assignee: Andreas Stihl AG & Co. KG, Waiblingen (DE)

(21) Appl. No.: 19/410,788

(22) Filed: Dec. 5, 2025

(30) Foreign Application Priority Data
Dec. 20, 2024 (DE) 102024139423.4

(51) Int. Cl. H02P 6/20; H02K 7/14; H02P 6/182; H02P 6/24; H02P 6/28; H02P 23/00

(52) U.S. Cl. CPC H02P 6/20; H02K 7/145; H02P 6/182; H02P 6/24; H02P 6/28; H02P 23/0027

(57) ABSTRACT

A method for starting an EC motor having a stator and a rotor, comprising the steps of determining a first position of the rotor when the rotor is stationary by means of discrete signal injection, accelerating the rotor by means of a controlled rotating field, determining a speed of the rotor on the basis of a back EMF after reaching a predetermined rotating field frequency, comparing the speed determined, with a first predetermined speed value, and, if the speed determined is greater than the first predetermined speed value, determining a second position of the rotor on the basis of the back EMF and changing to a closed-loop operation on the basis of the back EMF.

### CROSS-REFERENCE TO RELATED APPLICATIONS

This application claims priority of German Patent Application No. 10 2024 139 423.4, filed Dec. 20, 2024. The disclosure of this prior application is considered part of the disclosure of this application and is hereby incorporated by reference in its entirety.

### FIELD

The disclosure relates to a method for starting an electronically commutated (EC) motor and an assembly with an EC motor and a controller, wherein the controller is adapted to carry out such a method. The present disclosure also relates to a tool and devices, each having such an assembly.

### BACKGROUND

Motor-driven tools, in particular garden tools, devices used in landscape maintenance or in road maintenance depots or devices used in agriculture or forestry, often require a high starting torque in order to drive the equipment used with the tools.

Conventional methods for starting a motor, in particular an electronically commutated (EC) motor, of such tools with a correspondingly high starting torque usually require the use of special sensor systems, for example on the basis of Hall sensors, to determine an initial position of the rotor and then move the rotor to a defined starting position so that it may be accelerated starting from this starting position.

However, the rotor must typically be load-free for the initial position determination and alignment, which may be a limitation. In addition, the alignment of the rotor prior to the motor start is comparatively time-consuming and leads to a latency between the request for motor power (such as by an operator of the motor-driven tool) and the provision of the requested motor power. This delay may be perceived as unpleasant by the operator.

### SUMMARY

As a first example, the disclosure is based on a method for starting an EC motor having a stator and a rotor, comprising the steps:
(a) determining a first position of the rotor when the rotor is stationary by means of discrete signal injection;
b) accelerating the rotor by means of a controlled rotating field;
c) determining a speed of the rotor on the basis of a back EMF after reaching a predetermined rotating field frequency in step b);
d) comparing the speed determined in step c) with a first predetermined speed value; and
e) if the speed determined in step c) is greater than the first predetermined speed value: determining a second position of the rotor on the basis of the back EMF and changing to a closed-loop operation on the basis of the back EMF.

The disclosure is thus based on the surprising realization that the position information of the rotor required for a suitable current supply to the coils of the motor may be determined particularly easily and reliably by means of discrete signal injection. As a result, the previous need to move the motor to a defined starting position is eliminated. Instead, the rotor may be accelerated directly from the initial (first) position by activating the coils relevant for the first position.

The proposed method further and above all eliminates the latency previously attributable to the alignment of the rotor. Moreover, the rotor does not have to be load-free during the starting process. As a result, the motor may be started particularly easily and without additional means with the proposed method, even under conditions that have traditionally required further measures. For example, the proposed method may also be used to start the motor of a garden tool where the equipment, which is driven by the motor, is stuck as a result of previous use, making the motor not load-free.

In this way, a high starting torque may advantageously be achieved without or at least with reduced latency. In addition, the determination of the rotor position may be performed without or with fewer sensors when using discrete signal injection. In particular, Hall sensors, for example, may be dispensed with. As a result, costs and maintenance effort for corresponding motors decrease.

Furthermore, by determining the speed of the rotor achieved as a result of the acceleration in step c), it may particularly easily and reliably be determined whether the expected speed of the rotor for the then existing rotating field frequency has set. For this purpose, a threshold value is defined with the first predetermined speed value, and if the speed is greater than this threshold value, in addition to determining the second position of the rotor, a change is made to a closed-loop operation (in particular from the acceleration of the rotor by means of a controlled rotating field).

By testing the speed reached by the rotor, it may consequently be detected if the acceleration of the rotor (such as by changing the rotating field frequency of the controlled rotating field in step b)) has been too fast for a given load. Thanks to this test, it may advantageously be tried initially to start the rotor with lower currents and/or power. Thanks to the possibility of working with lower currents (in particular current amplitudes) and/or power (in particular power amplitudes) (such as when energizing the motor coils) electronics controlling the starting process and the motor itself may be preserved and overheating may be avoided.

The proposed method thus enables starting an EC motor with a high starting torque in a cost-efficient yet effective and efficient manner, while at the same time providing the greatest possible comfort for the operator and minimizing the load on motor and electronics.

Advantageously, one or more coils of the motor are identified by means of the first position of the rotor determined in step a), for which the acceleration of the rotor, in particular the acceleration performed in step b), must be energized at least temporarily (in particular at the start of the acceleration in step b)).

The discrete signal injection may involve injecting a periodic high-frequency voltage signal into the coils of the motor and identifying the first position based on the resulting high-frequency currents.

Advantageously, the acceleration in step b) involves an open-loop operation. The acceleration ramps up, i.e., increases the speed of the rotor. The curve of the speed during acceleration in step b) may, for example, be calculated and/or specified before acceleration begins. The speed curve and thus the ramping up may, for example, depend on whether step b) is performed for the first time or in how many repetitions step b) has been performed. The repetition option will be discussed in more detail below.

In examples, the acceleration in step b) may be or involve a time-dependent acceleration. It is particularly advantageous if the acceleration in step b) has different rates of change of the speed in different time periods. For example, a quadratic speed change may take place in at least a first time period. Alternatively or in addition, a linear speed change may take place in at least a second time period.

In one example, the acceleration of the rotor in step b) involves adjusting a motor current, in particular an initial motor current during acceleration, as a function of a motor temperature.

In one example, the acceleration of the rotor in step b) involves a control so that a motor current amplitude is constant. This enables a rapid increase (ramp up) of the speed. Alternatively, the method may also be adjusted for a comparatively gentle start-up of the rotor over a longer period of time compared to rapid ramping up. For the gentle start-up of the rotor, the acceleration of the rotor in step b) may comprise a variable motor current amplitude.

Advantageously, during the acceleration of the rotor in step b), an I-f starting method may be carried out at least temporarily and/or at least partially. For example, the open-loop operation may be performed completely or partially by means of the I-f starting method.

The acceleration of the rotor in step b) by means of the controlled rotating field advantageously exhibits at least temporarily a continuous increase in the rotating field frequency.

Additionally or alternatively, the acceleration of the rotor in step b) by means of the controlled rotating field may be performed during a defined period of time. In particular, if step b) is repeated, as described in more detail below, the defined time period is adjusted, in particular revalidated, compared to the previous execution of step b).

The rotating field frequency (of the controlled rotating field) is the frequency of the controlled rotating field. In particular, the motor current amplitude is dependent on the rotating field frequency.

Advantageously, the determination of the speed of the rotor in step c) involves the use of an FOC with a flux observer. For example, the determination of the speed of the rotor in step c) may involve a determination of one or more of the voltages induced in the coils of the motor, in particular after the coil current has been regulated to zero.

The determination of the speed of the rotor in step c) may, for example, be a direct or indirect determination of the speed of the rotor. For example, an indirect determination of the speed may be made via the motor voltage. For example, it is possible to utilize the fact that there is typically a linear relationship between the voltage induced in the motor windings (motor voltage) and the speed (EMF voltage). In addition, it is known to those skilled in the art that an angular velocity could also be determined instead of a speed, as there is a known relationship between them.

In one example, the determination of the speed of the rotor on the basis of the back EMF in step c) begins after the acceleration in step b) has been completed. However, in examples, the determination of the speed of the rotor on the basis of the back EMF in step c) may also begin at least partially during the acceleration of the rotor in step b). In other words, steps b) and c) may then at least partially overlap and thus represent at least partially parallel steps.

The term back EMF stands for back electromotive force, and is known to those skilled in the art per se.

In particular, the first and/or second rotor position is included for the change to the closed-loop operation carried out in step e). As a result, the change may be performed taking into account the corresponding rotor position.

In particular, a continuous determination of a third position of the rotor on the basis of the back EMF is performed in step e) after the change to the closed-loop operation. A continuous determination of the third position of the rotor, for example, may have or represent a periodically repeated determination of the third position of the rotor. As a result, a determination of the third position of the rotor may be performed at defined intervals.

As a result, a current position value is available for the rotor, which may be advantageously used for further measures. The third position may have a new value for each new determination.

The first position may conveniently be an angular position of the rotor. The second position may conveniently be an angular position of the rotor. The third position may conveniently be an angular position of the rotor.

The second position is advantageously only required when the speed determined in step c) is greater than the first predetermined speed value. Nevertheless, it is particularly advantageously possible to determine the second position already in step c) on the basis of the same data as the speed of the rotor, in particular at the same time. As a result, the engine may be started more quickly and therefore particularly efficiently. In alternative examples, it may therefore be provided that the second position of the rotor is not determined in step e), but in step c), in particular simultaneously with the speed and/or on the basis of the same data as the speed of the rotor, on the basis of the back EMF. Step c) then reads: determining a speed of the rotor and a second position of the rotor on the basis of, in particular a single, back EMF after reaching a predetermined rotating field frequency in step b). And optionally, step e) then reads: if the speed determined in step c) is greater than the first predetermined speed value: change to a closed-loop operation on the basis of the back EMF. All the advantages and options described also apply equally to this alternative example, unless the context indicates otherwise. This example is also addressed again below in a separate example.

A controlled rotating field is understood in particular to mean an open-loop control (which is also referred to here as open-loop operation), in particular by impressing a current, by specifying an angle and/or adjusting a motor current amplitude. In particular, the impressed current is a current that flows into the motor (motor phase). Depending on the internal wiring, the current may be divided into different winding heads.

A motor current amplitude is understood in particular to be the amplitude of the motor current, which is made up in particular of a field-forming motor current component i_{d} and a moment-forming motor current component i_{q}. The motor current amplitude may be calculated, for example, from the phase currents I_{U}, I_{V} and I_{W}. This results in the motor current amplitude for

$$I = \sqrt{{I}_{α}^{2} + {I}_{β}^{2}} .$$

The currents I_{α} and I_{β} may be calculated using the following relationship:

$$[ \begin{matrix}{I}_{α} \\ {I}_{β}\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{I}_{U} \\ {I}_{V} \\ {I}_{W}\end{matrix} ]$$

Since there are no (real) d and q currents in the open-loop operation, it is advantageous to use the relationship with the phase currents.

In particular, the rotor angle of the motor is known in the closed-loop operation, which in particular has or represents a closed-loop current control. This may be used, for example, for a coordinate transformation of the motor currents. In the open-loop operation, which in particular has or represents an open-loop current control, a rotor angle of the motor is assumed in particular (for example a “ramped up” angle from the open-loop ramp-up). However, this does not necessarily correspond to the current rotor angle of the motor.

The closed-loop operation may also be referred to as closed-loop current control. In particular, the closed-loop operation includes a field-oriented control (FOC).

For example, the closed-loop operation may involve: initializing a flux observer based on a position of the rotor, in particular the second position of the rotor; and operating the rotor by means of field-oriented control (FOC).

Alternatively or additionally, it may also be provided that the discrete signal injection in step a) comprises a defined and/or finite number of pulses.

Advantageously, the shape, the period of time (in particular the half-width) and/or the sequences of the phases of the individual pulses are defined in advance. In examples, the pulses are each identically designed. Advantageously, the time interval between immediately successive pulses is predefined.

For example, the discrete signal injection in step a) has between one and one hundred pulses.

For example, the discrete signal injection in step a) has at least one, in particular exactly one, INFORM pulse. INFORM stands for INdirect Flux detection by Online Reactance Measurement and is known to those skilled in the art per se.

Alternatively or additionally, it may also be provided that step b) comprises: accelerating the rotor, wherein a motor current is regulated and an amplitude of the motor current is dependent on the controlled rotating field, wherein the amplitude of the motor current is in particular constant.

In this way, the acceleration of the motor may be performed particularly reliably and yet in a comparatively easy manner.

Alternatively or additionally, it may also be provided that step c) comprises: determining the speed of the rotor on the basis of the back EMF after reaching a defined time.

In particular, the defined time refers to an elapsed time since the start of acceleration in step b).

Accordingly, the determination of the speed of the rotor on the basis of the back EMF in step c) is only performed after reaching the predetermined rotating field frequency in step b) and after reaching the defined time, i.e., when both conditions have been met. In particular, the predetermined rotating field frequency is reached after the defined time. Thus, the defined time corresponds to the period of time required to reach the predetermined rotating field frequency.

The determination of the speed in step b) (also) as a function of reaching a defined time makes it advantageous to further specify the start of the speed determination. By specifying the time, the speed may be determined particularly easily and yet reliably at a point in time from which an initial acceleration process is or at least should be completed as planned. In this way, the acceleration process may be performed very reliably.

Alternatively or additionally, it may also be provided that step c) comprises: determining the speed of the rotor using a set motor voltage, in particular reducing the amplitude of the motor current in time before determining the speed.

For example, the motor voltage (voltage induced in the windings) may be determined more robustly and accurately by means of zero current control via the set motor voltage.

Additionally or alternatively, the method involves that zero current control is performed in time between step b) and step c).

A zero current control may, for example, involve regulating the motor current in the three motor phases to 0 A.

In particular, step c) comprises controlling a motor current amplitude to a setpoint zero value and/or reducing the motor current to zero and/or close to zero, in particular by controlling the motor current amplitude to a setpoint zero value.

Alternatively or additionally, it may also be provided that step c) comprises: determining the speed of the rotor via a measured motor voltage during freewheeling.

This is a particularly easy and yet reliable way of determining the speed.

For this purpose, the rotor may be operated during freewheeling and the motor voltage may be measured in the meantime. For example, the motor voltage may be an induced voltage during freewheeling.

The rotor is freewheeling when no voltage is applied to the motor phases.

Alternatively or additionally, it may also be provided that if the speed determined in step c) is lower than the first predetermined speed value, a step f) to be carried out after step d) comprises: braking the rotor and repeating steps a) to d).

Consequently, if the speed determined in step c) is lower than the first predetermined speed value, i.e., the expected speed of the rotor for the rotating field frequency existing in step c) has not then been set in examples, the starting process may be attempted again in a new start-up after breaking the rotor, in particular with adjusted parameters of the motor. For example, higher currents (in particular current amplitudes) and/or power (in particular power amplitudes) may then be used (such as when energizing the motor coils). In this case, step e) is conveniently not carried out.

In examples, repeating steps a) to d) and, if necessary, a carrying out of step e) is provided in time after breaking the rotor.

Repeating step b), in particular repeating steps a) to d), enables that a jerk of the motor may be reduced compared to the previous step b). This is because it is convenient to adjust the acceleration and/or the jerk of the speed ramp when repeating step b), in particular steps a) to d).

In particular, it may be provided that, when repeating step b) compared to the previous step b), the controlled rotating field and/or a motor current amplitude dependent on the rotating field frequency and/or a motor temperature is adjusted.

Alternatively or additionally, it may also be provided that step f) comprises: Braking by means of short-circuit braking.

Consequently, the braking of the rotor in step f) may involve performing a short-circuit braking, in particular for a defined period of time.

For example, the braking may be performed for a defined period of time. In examples, the braking of the rotor comprises braking the rotor to a standstill. For example, the defined period of time may be selected to be correspondingly long. As a result, the standstill may be reached reliably.

Alternatively or additionally, it may also be provided that step f) comprises: braking to a speed of the rotor that is less than a second predetermined speed value.

As a result, a clearly defined situation for repeating the steps may be established particularly reliably.

In particular, the second predetermined speed value is a maximum of 20% and/or a minimum of 10% of a nominal speed of the rotor and/or the first predetermined speed value.

Alternatively or additionally, it may also be provided that step f) comprises: determining the speed based on the amplitude of the motor current and/or a frequency of the motor current.

For example, the defined duration may be determined on the basis of the speed. This means that the defined period of time for braking may be selected longer for higher speeds than for lower speeds. Thus, braking may be performed very efficiently as part of the starting process.

Alternatively or additionally, it may also be provided that, when repeating step b) compared to the previous step b), the controlled rotating field and/or the amplitude of the motor current dependent in particular on the rotating field frequency is adjusted.

By adjusting the controlled rotating field and/or the amplitude of the motor current, it is possible, for example, to react particularly easily and reliably to the presence of a higher load compared to an expected standard load and the rotor may then advantageously be started completely under these conditions during the next start-up (or advantageously after one or more further repetitions). This may be convenient, for example, in the case of a stuck tool (such as resin-coated knives of a hedge trimmer) that is driven by the motor.

Thanks to adjusted parameters, the rotor may advantageously be set in motion with less jerk and/or less acceleration when repeating step b) compared to the previous step b).

For example, the controlled rotating field may be generated with a reduced rate of change of the rotating field frequency when repeating step b) compared to the previous step b). As a result, a higher load may also be “taken” safely to some extent.

For example, the amplitude of the motor current may be increased and/order decreased when repeating step b) compared to the previous step b). As a result, a higher load may also be “taken” safely to some extent. Thus, it may be started with a lower current and then higher currents may be set as required.

Low currents have the advantages already mentioned above and therefore advantageously enable the thermal load on the electronics and/or the motor to be reduced.

Optionally, when repeating step b) in comparison to the previous step b), the speed of the rotor may be determined on the basis of the back EMF after reaching a newly defined time. As a result, the times according to which the speed is determined differ for the first test and the repetition.

If step b) is repeated more than once, the controlled rotating field and/or the motor current amplitude are advantageously adjusted in at least one of the at least one further repetition with different absolute changes to the parameters in each case, in particular the rate of change of the rotating field frequency and/or the motor current amplitude.

Alternatively or additionally, it may also be provided that, when repeating step b) compared to the previous step b), the controlled rotating field and/or the amplitude of the motor current dependent in particular on the rotating field frequency is gradually adjusted with increasing step width.

This means that with each repetition of step b), the controlled rotating field and/or the amplitude of the motor current is adjusted. As a result, the starting of the motor may be performed particularly efficiently.

According to a second aspect, the disclosure is based on a method for starting an EC motor having a stator and a rotor, comprising the steps:
(a) determining a first position of the rotor when the rotor is stationary by means of discrete signal injection;
b) accelerating the rotor by means of a controlled rotating field;
c) determining a speed of the rotor and a second position of the rotor on the basis of a, in particular a single, back EMF after reaching a predetermined rotating field frequency in step b);
d) comparing the speed determined in step c) with a first predetermined speed value; and
e) if the speed determined in step c) is greater than the first predetermined speed value: change to a closed-loop operation on the basis of the back EMF.

The method according to the second example of the disclosure thus differs from the method according to the first example of the disclosure in particular in that the second position of the rotor is not determined in step e), but in step c). As a result, the engine may be started more quickly and therefore particularly efficiently.

All the advantages and options described in relation to the method according to the first example of the disclosure also apply accordingly to the method according to the second example of the disclosure, unless the context indicates otherwise. Therefore, reference may be made to the previous explanations at this point.

According to a third aspect, the disclosure is based on an assembly having an EC motor having a stator and a rotor, and a controller electrically connected or connectable to the EC motor, wherein the controller is adapted to carry out a method according to the first and/or second example of the disclosure.

All the advantages described in relation to the method according to the first and/or second example of the disclosure also apply accordingly to the assembly according to the third example of the disclosure. Therefore, reference may be made to the previous explanations at this point.

The features described in relation to the method according to the first and/or second example of the disclosure may also be intended accordingly for the assembly, and in particular for the controller, individually and in any combination, unless the context indicates otherwise.

In particular, the controller is adapted to perform the method according to the first and/or second example of the disclosure. For this purpose, the controller may interact with the other components of the motor, such as rotor and stator. The controller may be operatively connected to the rotor and/or stator.

The controller may be implemented, for example, in software, in hardware, or as a combination of both. The controller may be a device for processing data. Alternatively or additionally, the controller may have a memory, a processor, a receiving apparatus, a transmitting apparatus, or any combination thereof. Alternatively or additionally, the controller may provide and/or make available and/or have everything that it has, in particular all the necessary resources, for example in the form of software and/or hardware resources.

The controller is conveniently connected to the motor electrically and/or via data technology.

The controller advantageously has interfaces for receiving sensor signals and/or for transmitting commands and/or means for processing, evaluating, and/or analyzing the respective signals.

According to a fourth aspect, the disclosure is based on a garden tool, a device used in landscape maintenance or in road maintenance depots and/or a device used in agriculture or forestry, each having an assembly according to the third example of the disclosure, wherein (i) the garden tool or the device is operable by means of a rechargeable battery and/or (ii) the garden tool or the device is designed as a hedge trimmer or a rotary trimmer or a grass trimmer or a hedge cutter or a pruner or a drill or a blowing or a cleaning device, in particular a high-pressure cleaner, or a suction device or a sprayer and/or spraying device or a saw or a wood cutter or a pruning shears or a multi-tool or a brush cutter or a rock cutter or a cut-off grinder.

All the advantages described in relation to the method according to the first and/or second example of the disclosure also apply accordingly to the tool and the devices according to the fourth example of the disclosure. Therefore, reference may be made to the previous explanations at this point.

Further features and advantages of the disclosure will become apparent from the following description, in which examples of the disclosure described in detail are explained using schematic drawings:

### BRIEF DESCRIPTION OF THE DRAWINGS

FIG. 1 shows a flow chart of a method according to the first example of the disclosure;

FIG. 2 shows a flow chart of a method according to the second example of the disclosure;

FIG. 3 shows a schematic representation of an assembly according to the third example of the disclosure; and

FIG. 4 shows a schematic representation of a garden tool and/or a device according to the fourth example of the disclosure.

### DETAILED DESCRIPTION

FIG. 1 shows a flow chart 100 of a method according to the first example of the disclosure. The method serves to start an EC motor having a stator and a rotor.

In step 101, a first position of the rotor is determined when the rotor is stationary by means of discrete signal injection. The first position may be an angle of the rotor.

For example, the discrete signal injection may be performed by means of an INFORM pulse.

In step 103, the rotor is accelerated by means of a controlled rotating field.

The acceleration may have an open-loop operation. The speed of the rotor is ramped up, i.e., increased. The curve of the speed may be calculated before the beginning of acceleration, for example. The speed curve and thus the ramping up may depend, for example, in which number of repetitions step 103 is performed. For example, the acceleration is time-dependent. Here, different rates of change may be provided in different time ranges. In one time range, for example, a linear rate of change may be provided.

In step 105, a speed of the rotor is determined on the basis of a back EMF after reaching a predetermined rotating field frequency in step 103.

In step 107, the speed determined in step 105 is compared with a first predetermined speed value.

If the speed determined in step 105 is greater than the first predetermined speed value, a second position of the rotor is determined in step 109 on the basis of the back EMF and a change is made to closed-loop operation on the basis of the back EMF.

The second position may be an angle of the rotor.

As part of the closed-loop operation, for example, a flux observer may be initialized based on the second position of the rotor and the rotor may be operated using field-oriented control (FOC).

Optionally, if the speed determined in step 105 is lower than the first predetermined speed value, the rotor may be braked in step 111 following step 107 and steps 101 to 107 may be repeated. Subsequently, depending on the speed then determined in step 105, the rotor may either be operated in accordance with step 109 or the rotor may be braked again in step 111, optionally followed by at least one further repetition of steps 101 to 107.

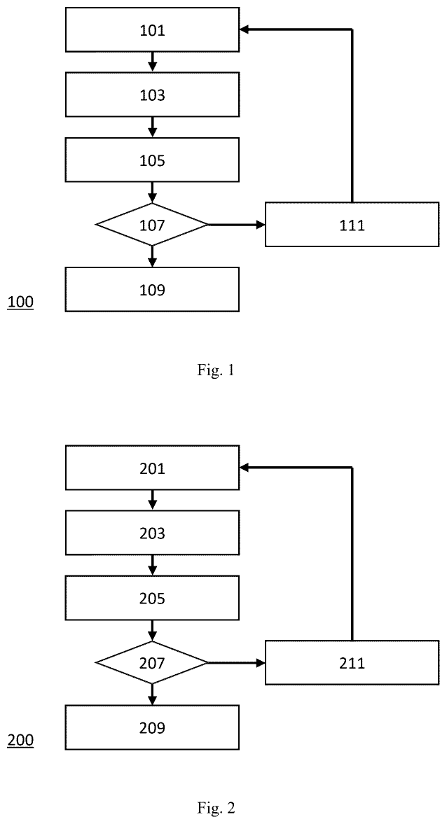

FIG. 2 shows a flow chart 200 of a method according to the second example of the disclosure. The method also serves to start an EC motor having a stator and a rotor. The method is quite similar to the method according to the first example of the disclosure described with reference to the flowchart 100 of FIG. 1. The steps 201, 203, 207 and 211 correspond precisely to the steps 101, 103, 107 and 111.

However, in step 205, a speed of the rotor and a second position of the rotor are determined on the basis of a, in particular a single, back EMF after reaching a predetermined rotating field frequency in step 203.

The second position may be an angle of the rotor.

If the speed determined in step 205 is greater than the first predetermined speed value, a change is made to closed-loop operation in step 209 on the basis of the back EMF.

In other words, the determination of the second position of the rotor now already takes place in step 205 instead of in step 209.

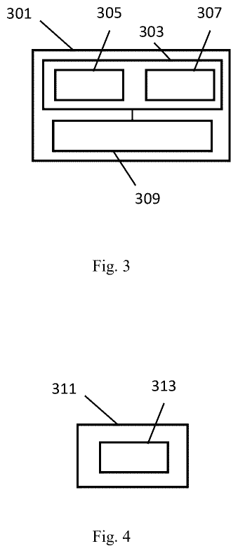

FIG. 3 shows a schematic representation of an assembly 301 according to the third example of the disclosure.

The assembly 301 has an EC motor 303. The EC motor has a stator 305 and a rotor 307. The EC motor 301 is electrically connected to a controller 309.

The controller 309 is adapted to carry out a method according to the first and/or second example of the disclosure. As a result, the controller 309 may start the motor 303 in a particularly advantageous manner. This may be done, for example, with the method according to the first example of the disclosure described with reference to the flowchart 100 of FIG. 1 or with the method according to the second example of the disclosure described with reference to the flowchart 200 of FIG. 2.

FIG. 4 shows a schematic representation of a garden tool and/or a device 311 according to the fourth example of the disclosure.

The tool and/or device 311 comprises an assembly 313 according to the third example of the disclosure. The assembly 313 may, for example, be identical to the assembly 301.

For example, the device may be a device used in landscape maintenance or road maintenance depots and/or a device used in agriculture or forestry. The tool and/or device 311 may be, for example, a hedge trimmer or a chainsaw.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method for starting an EC motor having a stator and a rotor, comprising the steps of:
(a) determining a first position of the rotor when the rotor is stationary by means of discrete signal injection;
(b) accelerating the rotor by means of a controlled rotating field;
(c) determining a speed of the rotor on the basis of a back EMF after reaching a predetermined rotating field frequency in step (b);
(d) comparing the speed determined in step (c) with a first predetermined speed value; and
(e) if the speed determined in step (c) is greater than the first predetermined speed value:
determining a second position of the rotor on the basis of the back EMF and changing to a closed-loop operation on the basis of the back EMF.

2. The method according to claim 1, wherein the discrete signal injection in step (a) comprises at least one of a defined or finite number of pulses.

3. The method according to claim 1, wherein step (b) comprises:
accelerating the rotor, wherein a motor current is regulated and an amplitude of the motor current is dependent on the controlled rotating field, wherein the amplitude of the motor current is in particular constant.

4. The method according to claim 1, wherein step (c) comprises:
determining the speed of the rotor on the basis of the back EMF after reaching a defined time.

5. The method according to claim 1, wherein step (c) comprises:
determining the speed of the rotor using a set motor voltage, in particular reducing the amplitude of the motor current in time before determining the speed.

6. The method according to claim 1, wherein step (c) comprises:
determining the speed of the rotor via a measured motor voltage during freewheeling.

7. The method according to claim 1, wherein, if the speed determined in step (c) is lower than the first predetermined speed value, a step (f) to be carried out after step (d) comprises:
braking the rotor and repeating steps (a) to (d).

8. The method according to claim 7, wherein step (f) further comprises:
braking by means of a short-circuit braking.

9. The method according to claim 7, wherein step (f) further comprises:
braking to a speed of the rotor that is less than a second predetermined speed value.

10. The method according to claim 7, wherein step (f) further comprises:
determining the speed based on at least one of the amplitude of the motor current or a frequency of the motor current.

11. The method according to claim 7, wherein, when repeating step (b) compared to the previous step (b), at least one of the controlled rotating field or the amplitude of the motor current dependent in particular on the rotating field frequency is adjusted.

12. The method according to claim 7, wherein, when repeating step (b) compared to the previous step (b), at least one of the controlled rotating field or the amplitude of the motor current dependent in particular on the rotating field frequency is gradually adjusted with increasing step width.

13. An assembly, having an EC motor having a stator and a rotor, and a controller electrically connected or connectable to the EC motor, wherein the controller is adapted to carry out the method according to claim 1.

14. The assembly according to claim 13, in particular for a garden tool, a device used in landscape maintenance or in road maintenance depots, or a device used in agriculture or forestry, wherein the assembly is operable by means of a rechargeable battery.

15. A method for starting an EC motor having a stator and a rotor, comprising the steps of:
(a) determining a first position of the rotor when the rotor is stationary by means of discrete signal injection;
(b) accelerating the rotor by means of a controlled rotating field;
(c) determining a speed of the rotor and a second position of the rotor on the basis of a single back EMF after reaching a predetermined rotating field frequency in step (b);
(d) comparing the speed determined in step (c) with a first predetermined speed value; and
(e) if the speed determined in step (c) is greater than the first predetermined speed value: change to a closed-loop operation on the basis of the back EMF.

16. The method according to claim 15, wherein the discrete signal injection in step (a) comprises at least one of a defined or finite number of pulses.

17. The method according to claim 15, wherein step (b) comprises:
accelerating the rotor, wherein a motor current is regulated and an amplitude of the motor current is dependent on the controlled rotating field, wherein the amplitude of the motor current is in particular constant.

18. The method according to claim 15, wherein step (c) comprises:
determining the speed of the rotor on the basis of the back EMF after reaching a defined time.

19. The method according to claim 15, wherein step (c) comprises:
determining the speed of the rotor using a set motor voltage, in particular reducing the amplitude of the motor current in time before determining the speed.

20. The method according to claim 15, wherein step (c) comprises:
determining the speed of the rotor via a measured motor voltage during freewheeling.
